(19) United States
(12) Patent Application Publication
(10) Pub. No.: US 2014/0173759 A1
(43) Pub. Date: Jun. 19, 2014

(54) RIGHTS-MANAGED CODE

(71) Applicant: MICROSOFT CORPORATION, Redmond, WA (US)

(72) Inventors: Bill Essary, Sammamish, WA (US); Stephen H. Toub, Seattle, WA (US)

(73) Assignee: MICROSOFT CORPORATION, Redmond, WA (US)

(21) Appl. No.: 13/716,887

(22) Filed: Dec. 17, 2012

(51) Int. Cl. G06F 21/62

(52) U.S. Cl. CPC G06F 21/6209
USPC 726/30

(57) ABSTRACT

Methods, systems, and computer program products are provided for providing controlled access to source code. The source code is encrypted. Access rights to the encrypted source code are configured. The encrypted source code is hosted at a network-accessible location. An access attempt for the encrypted source code by a digital rights management (DRM) enabled software development tool is received. Access to the encrypted source code by the DRM enabled software development tool is enabled according to the configured access rights.

### BACKGROUND

Source code is a collection of computer program instructions that is written by a code developer in a human-readable programming language. Software development environments exist that aid software developers in writing such source code. A software development environment may include various tools such as a source code editor for entering and editing source code, one or more build automation tools for compiling source code, and a code debugger. Examples of commercially available software development environments include Microsoft® Visual Studio®, developed by Microsoft Corporation of Redmond, Wash., JDeveloper® supplied by Oracle Corporation of Redwood City, Calif., and ActiveState® Komodo® provided by ActiveState Software Inc. of Vancouver, British Columbia.

In some situations, access to source code may be controlled or limited to particular persons. For instance, access to source code may be controlled for purposes of security (e.g., to prevent code theft, etc.). Access to source code may be controlled in various ways, such as by providing a portal (e.g., a terminal or workstation) that limits access to the source code, in effect, controlling the environment through which the source code may be reached and interacted with. Persons may be enabled to access the source code through the portal using a special user account (e.g., a guest account) that is able to navigate and view the source code. In another example, in a source control repository that contains source code files, permissions may be set that grant users permissions to access particular source code files based on the identities of the users. For instance, a user may be granted permission to read particular source code files, but may not be granted permission to write to those files.

Digital rights management (DRM) is a class of access control technologies used by hardware manufacturers, publishers, copyright holders, and individuals with the intent to limit the use of digital content and devices after sale. For example, Microsoft® Office developed by Microsoft Corporation applies DRM technology to control access to Microsoft® Word documents, Microsoft® PowerPoint spreadsheets, etc., with a limited set of permissions that can be applied.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for providing controlled access to source code. Access rights may be assigned to the source code, including conventional access rights (e.g., access rights such as read, write, etc.), as well as access rights that are tailored to source code and to a source code development environment (e.g., access rights such as compile, debug, analyze, profile, deploy, copy, print, email, save/save as, public metadata only, associated license, deployment site, and further access rights). The source code may be encrypted such that the encrypted source code is available and accessible to various computing devices, but the source code cannot be read, modified, or otherwise interacted with without first being decrypted. Software development tools that are DRM (digital rights management) enabled can decrypt and interact with the source code, as enabled by the particular access rights assigned to the source code.

According to one method implementation, the source code is encrypted. Access rights to the encrypted source code are configured. The encrypted source code is hosted at a network-accessible location. An access attempt for the encrypted source code by a DRM enabled software development tool is received. Access to the encrypted source code by the DRM enabled software development tool is enabled according to the configured access rights.

According to one system implementation, a source code access manager includes an encryption module, an access rights manager, and a code access interface. The encryption module is configured to encrypt the source code. The access rights manager is configured to enable access rights to the encrypted source code to be configured. The code access interface is configured to receive an access attempt for the encrypted source code by a DRM enabled software development tool, and to enable access to the encrypted source code by the DRM enabled software development tool according to the configured access rights.

According to another method implementation, an access of encrypted source code is attempted according to DRM enabled for a software development tool. Access to the encrypted source code is received. The encrypted source code is decrypted. The decrypted source code is accessed according to access rights configured for the encrypted source code at the server.

According to another system implementation, a software development tool includes a DRM module configured to enable DRM for the software development tool. The DRM module includes a code access requester, a decryption module, and an access rights enforcement module. The code access requester is configured to request and receive access to encrypted source code at a server over a network. The decryption module is configured to decrypt the encrypted source code. The access rights enforcement module is configured to enable access to the decrypted source code according to access rights configured for the encrypted source code at the server.

Computer program products containing computer readable storage media are also described herein that store instructions for controlling access to source code using DRM enabled tools, that store instructions for handling access rights tailored for source code and source code development tools, as well as enabling additional embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a software development system that controls access to source code for digital rights management (DRM) enabled development tools, according to an example embodiment.

FIG. 2 shows a flowchart providing a process for a DRM-enabled software development tool that attempts to access protected source code, according to an example embodiment.

FIG. 3 shows a block diagram of a software development environment including a plurality of software development tools and that attempts to access protected source code, according to an example embodiment.

FIG. 4 shows a flowchart providing a process for controlling access to source code by DRM enabled software development tools, according to an example embodiment.

FIG. 5 shows a block diagram of a system that controls access to source code by DRM enabled software development tools, according to an example embodiment.

FIG. 6 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Source code is a collection of computer program instructions that is written in a human-readable programming language. Software development environments exist that aid software developers in writing source code. A software development environment may include various tools such as a source code editor for entering and editing source code, one or more build automation tools for compiling source code, and a code debugger. In some situations, access to source code may be controlled or limited to particular persons and/or tools. For instance, access to source code may be controlled for purposes of security (e.g., to prevent code theft, etc.). Access to source code may be controlled in various ways, such as through the use of permissions to grant access for users to particular servers and source code files based on the identities of the users. In another example, a portal may be used to limit access to source code at a terminal or workstation, in effect, controlling the environment through which the source code may be reached and interacted with. RDP (Remote Desktop Protocol) developed by Microsoft Corporation and Citrix® provided by Citrix Systems, Inc. are example mechanisms for providing such portals.

Such techniques for controlling access to source code may be cumbersome, however, particularly when many individuals may need access to the source code (e.g., the developer, other developers working on the same or other portions of the source code, code reviewers, etc.). Furthermore, the constraints applied to the accessing of source code typically do not reach beyond normal access rights (e.g., read/view and write/modify). Still further, such techniques may not be fine grained enough because they apply to entire files, rather than being able to control access to portions of files by users, and rather than being able to control access by particular tools.

For instance, it may be desired to grant access for a first user to modify particular functions in a source code file, rather than having to grant the first user access to modify the whole file. It may be desired to prevent a second user from being able to read a particular source code file, while enabling the second user to compile that file. Furthermore, it may be desired to allow a third user to read a file, while preventing the third user from being able to copy-and-paste from the file. Presently known techniques for controlling access to source code are incapable of providing these types of access rights.

According to embodiments, access to source code is controlled using rights management techniques. For instance, in an embodiment, source code may be hosted on a network (e.g., hosted in the “cloud”) in an encrypted form. No special environment or portal is required to access the source code (although a special environment or portal may additionally be used to provide additional protection). Instead, the source code may be accessed directly using a rights management system that is established in the network. The complete development experience occurs in the network. Each tool that interacts with the source is rights management enabled, such as being digital rights management (DRM) enabled. One or more access rights may be applied to the encrypted source code, and the rights management enabled tools enable access to the encrypted source code in conformance with the access rights. New access rights are provided that are tailored to the source code development environment.

Accordingly, access rights applied to source code may be used to control various forms of access to the source code, including limiting what kinds of licenses can be associated with source code added to a project, controlling whether source code from the project can be shared, indicating which developers are allowed to view or modify particular pieces of source code, granting permissions according to architectural layers of a development system, etc. Further examples of access rights that may be enabled with respect to source code include “view but not copy”, “compile but not view”, “view only code that developer owns”, “show reference to code, rather than code itself”, etc. Access rights may be configured to prevent printing out of source code, prevent copying and pasting of source code into an application other one or more desired development tools, prevent emailing or uploading of the source code, etc.

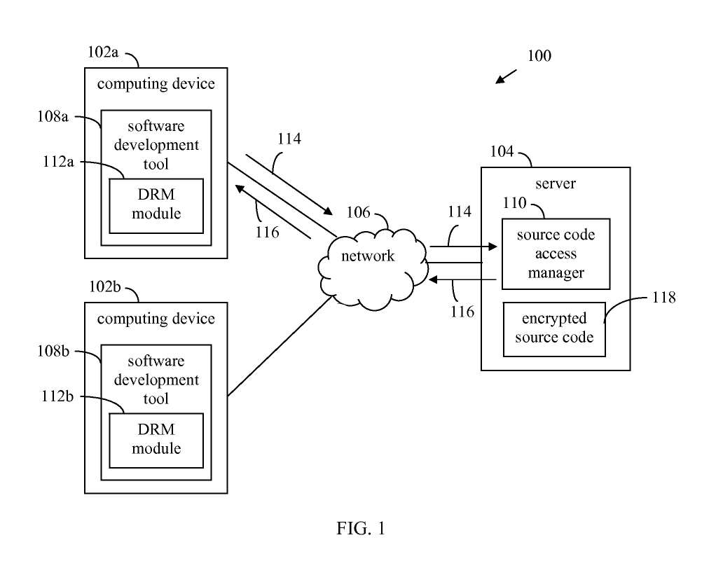

Embodiments may be configured in various ways to control access to source code. For instance, FIG. 1 shows a block diagram of a software development system 100 that controls access to source code for DRM enabled development tools, according to an example embodiment. As shown in FIG. 1, system 100 includes a first computing device 102a, a second computing device 102b, and a server 104, which are communicatively coupled by a network 106. As shown in FIG. 1, computing device 102a includes a software development tool 108a, computing device 102b includes a software development tool 108b, and server 104 includes a source code access manager 110. Furthermore, software development tool 108a includes a DRM module 112a and software development tool 108b includes a DRM module 112b. System 100 is provided as an example embodiment, and embodiments may be implemented in alternative environments. System 100 is described as follows.

Source code access manager 110 in server 104 is configured to control access to encrypted source code 118 at server. Encrypted source code 118 includes source code generated by one or more code developers, and that is encrypted to prevent reading of encrypted source code 118 by unauthorized entities. Source code access manager 110 may encrypt the source code, enable access rights to be applied to the source code, and facilitate access to encrypted source code 118 by developers and other entities according to the access rights.

As such encrypted source code 118 may be made widely accessible to computing devices at server 104 over network 106, but entities that access encrypted source code 118 are not enabled to view or otherwise interact with the source code encrypted therein, without first decrypting encrypted source code 118. Such an embodiment therefore provides advantages over conventional techniques that use a portal to constrain an environment in which source code may be accessed. Encrypted source code 118 may be widely accessed by computing devices, but the software development tools that access encrypted source code 118 have to be DRM enabled, as described herein, to interact with the source code encrypted therein.

For instance, source code access manager 110 may receive requests for access to encrypted source code 118 from software development tool 108a and software development tool 108b. For instance, as shown in FIG. 1, source code access manager 110 in server 104 may receive a request 114 from software development tool 108a in computing device 102a through network 106. A developer or other entity may interact with software development tool 108a to develop/program encrypted source code 118 in the form of program code, to compile the source code, to debug the source code, etc. In response to request 114, source code access manager 110 provides some or all of encrypted source code 118 to software development tool 108a. For example, as shown in FIG. 1, software development tool 108a in computing device 102a may receive encrypted source code portion 116 from source code access manager 110 in server 104. Encrypted source code portion 116 includes some of or the entirety of encrypted source code 118, and may include access rights information associated with the encrypted source code (e.g., in the form of metadata, etc.). DRM module 112a enables software development tool 108a to interact with encrypted source code portion 116 according to the access rights information.

For instance, DRM module 112a (and DRM module 112b) is enabled with DRM functionality, such as including one or more proprietary or commercially available access control technologies that limit the use of digital content after sale, and that are adapted to restricting access to source code in a software development environment as described herein. DRM module 112a enables DRM for software development tool 108a at least in part by enabling decryption for software development tool 108a, as well as controlling access to source code by software development tool 108a according to the access rights assigned to the source code (DRM module 112a prevents software development tool 108a from interacting with source code in violation of the assigned access rights).

Server 104 may be any type of computing device capable of serving content, and may include one or more computing devices. Computing devices 102a and 102b may each be any type of stationary or mobile computing device, including a stationary computer (e.g., a personal computer, a server, etc.) or a mobile computing device such as a handheld device (e.g., a Palm® device, a RIM Blackberry® device, a personal digital assistant (PDA)), a laptop computer, a notebook computer, a tablet computer (e.g., an Apple iPad™, a Microsoft Surface™, etc.), a netbook, a mobile phone (e.g., a smart phone such as an Apple iPhone, a Google Android™ phone, a Microsoft Windows® phone, etc.), or other type of computing device.

Software development tools 108a and 108b may each include any type of commercially available or proprietary software development tool, software development environment, or integrated development environment. Examples of software development tools include code editors, compilers, debuggers, static analysis tools, profilers, deployment tools, etc. Examples of software development environments include Microsoft® Visual Studio®, developed by Microsoft Corporation of Redmond, Wash., JDeveloper® supplied by Oracle Corporation of Redwood City, Calif., and ActiveState® Komodo® provided by ActiveState Software Inc. of Vancouver, British Columbia. These examples of software development tools 108a and 108b are provided merely for purposes of illustration, and are not intended to be limiting, as many further types of applicable software development tools and environments exist, as would be known to persons skilled in the relevant art(s).

Encrypted source code 118 may include source code of any type of programming language, including C/C++, VB.NET (Visual Basic .NET), C#, F#, M, Python, Ruby, XML/XSLT, HTML/XHTML, Java, JavaScript, CSS, SQL, BPEL, PHP, Perl, Tcl, etc. These examples of programming languages are provided merely for purposes of illustration, and are not intended to be limiting, as many further types of applicable programming languages exist, as would be known to persons skilled in the relevant art(s).

Computing devices 102a and 102b and server 104 are communicatively coupled by network 106. Network 106 may include one or more communication links and/or communication networks, such as a PAN (personal area network), a LAN (local area network), a WAN (wide area network), or a combination of networks, such as the Internet. Computing devices 102a and 102b and server 104 may be communicatively coupled to network 106 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Two computing devices 102a and 102b are shown in FIG. 1 for purposes of illustration. However, any number of computing devices may be present in system 100 that communicate with server 104 to access source code, including tens, hundreds, thousands, and even greater numbers of computing devices. Furthermore, although encrypted source code is described above as being transmitted from server 104 to computing devices 102a and 102b, in another embodiment, the encrypted source code may be operated on by software development tools 108a and/or 108b at server 104 over network 106. In another embodiment, encrypted source code 118 and software development tool 108a may reside in a same computing device, while source code access manager 110 is located at server 104. In still another embodiment, source code access manager 110, encrypted source code 118, and software development tool 108a may reside in a same computing device.

The elements of software development system 100 shown in FIG. 1 may be configured in various ways, in embodiments. Example embodiments for software development system 100 are described in the following subsections.

### A. Example Embodiments for Accessing Protected Source Code from a Software Development Tool

As described above, software development tools 108a and 108a are DRM enabled software development tools configured to access source code having associated access rights. Software development tools 108a and 108b may be configured in various ways, and may operate in various ways, in embodiments.

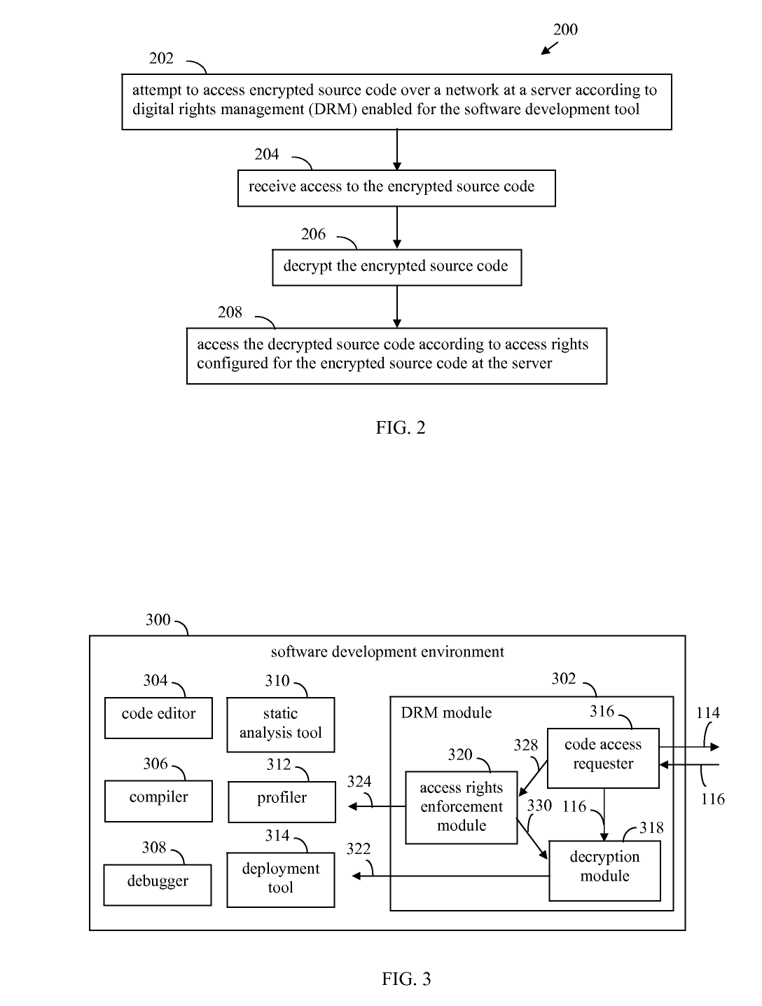

For example, FIG. 2 shows a flowchart 200 providing a process for a DRM-enabled software development tool that attempts to access protected source code, according to an example embodiment. Software development tools 108a and 108b of FIG. 1 may each operate according to flowchart 200, in an embodiment. For purposes of illustration, flowchart 200 of FIG. 2 is described with respect to FIG. 3. FIG. 3 shows a block diagram of a software development environment 300 including a plurality of software development tools and that attempts to access protected source code, according to an example embodiment. As shown in FIG. 3, software development environment 300 includes a DRM module 302, a code editor 304, a compiler 306, a debugger 308, a static analysis tool 310, a profiler 312, and a deployment tool 314. DRM module 302 is an example of DRM modules 112a and 112b in FIG. 1. DRM module 302 enables enforcement of access rights with respect to source code at software development environment 300. DRM module 302 includes a code access requester 316, a decryption module 318, and an access rights enforcement module 320. Software development environment 300 is an example of software development tool 108 of FIG. 1. In other embodiments, software development tool 108 may include DRM module 302 and any one or more of code editor 304, compiler 306, debugger 308, static analysis tool 310, profiler 312, and deployment tool 314. Flowchart 200 and software development environment 300 are described as follows. Further structural and operational embodiments will be apparent to persons skilled in the relevant art(s) based on the following description.

Flowchart 200 begins with step 202. In step 202, encrypted source code is attempted to be accessed over a network at a server according to digital rights management (DRM) enabled for the software development tool. According to embodiments, software development environment 300 enables encrypted source code to accessed, whether the source code is in a same device as software development environment 300, or is located over a network from software development environment 300. Referring to the example of FIG. 3, software development environment 300 may transmit request 114 to source code access manager 110 in server 104 (FIG. 1). Request 114 is a request by software development environment 300 to access encrypted source code 118. Software development environment 300 may desire to access encrypted source code 118 for various reasons.

For instance, referring to FIG. 3, request 114 may be generated based on code editor 304. A developer may interact with code editor 304 of software development environment 300 to enter and edit program code when generating source code included in, or to be included in encrypted source code 118. For instance, the developer may add, modify, or delete program code text using code editor 304 such as by typing, by voice input, etc. Code editor 304 may include a search and/or discovery tool (e.g., for performing key word searches on source code, etc.). When complete, or at other intervals, the user may be enabled to save the program code by interacting with a “save” button or other user interface element. As such, code editor 304 may cause request 114 to be transmitted in response to a developer attempting to develop decrypted source code 118 using code editor 304.

In another example, request 114 may be generated based on compiler 306. A user may interact with compiler 306 of software development environment 300 to compile source code of encrypted source code 118. Compiler 306 compiles source code by transforming the source code from the programming language in which it is written (the source language) into another computer language (the target language, often having a binary form known as object code), creating an executable program. As such, compiler 306 may cause request 114 to be transmitted in response to a user attempting to compile source code using compiler 306.

In another example, request 114 may be generated based on debugger 308. A user may interact with debugger 308 of software development environment 300 to debug source code of encrypted source code 118. Debugger 308 debugs source code by enabling the source code to be executed step by step, stopping execution at breakpoints, tracking the values of variables, and/or otherwise enabling source code to be tested. As such, debugger 308 may cause request 114 to be transmitted in response to a user attempting to debug source code using debugger 308.

In another example, request 114 may be generated based on static analysis tool 310. A user may interact with static analysis tool 310 of software development environment 300 to statically analyze source code of encrypted source code 118. Static analysis tool 310 may statically analyze source code (e.g., without execution) by performing model checking, data flow analysis, abstract interpretation, and/or other form of static analysis of the source code. As such, static analysis tool 310 may cause request 114 to be transmitted in response to a user attempting to perform static analysis on source code using static analysis tool 310.

In another example, request 114 may be generated based on profiler 312. A user may interact with profiler 312 of software development environment 300 to dynamically analyze source code of encrypted source code 118. Profiler 312 may dynamically analyze source code (e.g., during execution) by determining how much memory space is used by the running program, an amount of time used by various aspects of the running program, the usage of particular instructions, a frequency and/or duration of function calls, and/or other performing other forms of dynamic analysis of the source code. As such, profiler 312 may cause request 114 to be transmitted in response to a user attempting to profile source code using profiler 312.

In another example, request 114 may be generated based on deployment tool 314. A user may interact with deployment tool 314 of software development environment 300 to deploy source code of encrypted source code 118 to create a program instance. For instance, deployment tool 314 may deploy compiled source code to a location on a network to generate a program instance, or may deploy raw (un-compiled) source code to a location on a network. The un-compiled source code may be dynamically compiled (e.g., on a web server) on a first access and at any future point in time when the source code is changed. As such, deployment tool 314 may cause request 114 to be transmitted in response to a user attempting to deploy source code using deployment tool 314.

Code access requester 316 may monitor each of code editor 304, compiler 306, debugger 308, static analysis tool 310, profiler 312, and deployment tool 314 (that are present) for indications that an access of encrypted source code 118 (FIG. 1) is desired, and may generate request 114 in response. Request 114 may indicate that any portion of encrypted source code 118 is requested by a software development tool, including the entirety of encrypted source code 118.

Note that a request 114 need not be generated every time source code is attempted to be accessed. For instance, the client (e.g., computing device 102a) and server may reside in a same device and therefore a network request would not be needed. In another example, the client might cache access rights information received from the server such that subsequent requests may be satisfied from this local cache (until the cache expires for one reason or another).

Referring back to FIG. 2, in step 204, access to the encrypted source code is received. As shown in FIG. 3, in response to request 114, code access requester 316 receives encrypted source code portion 116 (from source code access manager 110 in FIG. 1). Encrypted source code portion 116 includes some or the entirety of encrypted source code 118, and may include access rights information associated with the encrypted source code (e.g., in the form of metadata, etc.). As shown in FIG. 3, code access requester 316 outputs encrypted source code portion 116 and access rights 328. Access rights 328 includes the access rights associated with encrypted source code portion 116.

In step 206, the encrypted source code is decrypted. As shown in FIG. 3, decryption module 318 receives encrypted source code portion 116. Furthermore, decryption module 318 receives decryption enable signal 330 from access rights enforcement module 320. Access rights enforcement module 320 generates decryption enable signal 330 based on access rights 328. Access rights enforcement module 320 analyzes access rights 328 to determine whether sufficient rights exist (e.g., read rights, compile rights, etc.) with respect to the requesting software development tool to decrypt encrypted source code portion 116. If sufficient rights are determined to exist, access rights enforcement module 302 generates decryption enable signal 330 to enable decryption module 318 to decrypt encrypted source code portion 116. If sufficient rights are determined to not exist, access rights enforcement module 302 generates decryption enable signal 330 to not enable decryption module 318 to decrypt encrypted source code portion 116.

As shown in FIG. 3, decryption module 318 decrypts encrypted source code portion 116 to generate decrypted source code portion 322. Decryption module 318 may be configured to use any suitable decryption technique to decrypt encrypted source code portion 116, as would be known to persons skilled in the relevant art(s) (e.g., using a private-key, a public-key, etc.).

Note that in another embodiment, rather than being enabled by decryption enable signal 330 to decrypt encrypt source code portion 116, decryption module 318 may automatically decrypt encrypt source code portion 116 when received (without need for an enable signal).

Referring back to FIG. 2, in step 208, the decrypted source code is accessed according to access rights configured for the encrypted source code at the server. As shown in FIG. 3, access rights enforcement module 320 generates an access enable signal 324 based on access rights 328. Access enable signal 324 indicates the type of access to decrypted source code portion 322 enabled for the requesting software development tool as indicated in access rights 328. Access enable signal 324 can indicate any type and combination of access rights for any portion of decrypted source code portion 322. In this manner, the requesting software development tool is enabled to interact with decrypted source code portion 322 according to the access rights applied thereto.

For instance, access enable signal 324 can grant any combination of the standard access rights of read, write (or “modify”), display, etc. Furthermore, access enable signal 324 can grant further types of access rights, and combinations thereof, that are tailored toward a software development environment, as well as to specific software development tools, such as compile, debug, analyze, profile, deploy, copy, print, email, save/save as, public metadata only, associated license, deployment site, etc. In an embodiment, if a particular access right is not granted, the applicable user and/or tool does not have the particular access right.

For instance, the “read” access right indicates whether the applicable source code of decrypted source code portion 322 may be read by a user and/or a software development tool, and the read access right may have modifiers applied thereto. For instance, “read by user” enables a user to read the applicable source code (similarly to the “display” access right, which enables the source code to be displayed). “Read by compiler” (or by other software development tool) enables the compiler (or other software development tool) to read the applicable source code.

The “write” (or “modify”) access right indicates whether the applicable source code may be written to by a user and/or a software development tool (e.g., by code editor 304, etc.).

The “compile,” “debug,” “analyze,” “profile,” and “deploy” access rights indicate whether the corresponding software development tool can interact with the applicable source code. For instance, “debug” may enable debugger 308 to debug the applicable source code, while “no debug” disables debugger 308 from debugging the applicable source code.

The “copy,” “print,” “email,” and “save/save as” access rights respectively indicate whether the corresponding software development tool can copy, print, email, or save the applicable source code. For instance, “copy” may enable code editor 304 to copy the applicable source code, while “no copy” may disable code editor 304 from copying the applicable source code. In another example, “save” and/or “save as” may enable a copy of the source code to be stored locally (e.g., at the client).

The “public metadata only” access right indicates that publicly available metadata associated with the applicable source code may be displayed without enabling the source code to be read/displayed at the software development tool.

The “associated license” access right indicates limitations on whether source code may be accessed (e.g., read) by a user based on a license associated with the source code. For instance, metadata for source code may store license information indicating a license associated with the source code. The “associated license” right, when assigned, is configurable to enable a user to read or not read the source code based on the license and information about the user. In another embodiment, the associated license access right may be configured such that only particular licenses are allowed to be associated with particular source code. For instance, particular source code may have license information associated with it (e.g., Apache, MS-PL, GPL v3, etc.), and the associated license access right may be assigned to cause any attempt to paste in additional code having metadata that indicates a different associated license to not be allowed.

The “deployment site” access right indicates limitations as to which server(s) the applicable source code may be deployed. For instance, the deployment site access right may indicate one or more servers to which a particular user may deploy the source code.

These and further access rights may be combined in access enable signal 324 in any manner as would be apparent to persons skilled in the relevant art(s) from the teachings herein. For instance, a “read but not copy access right” (or a combination of a “read by user” access right being assigned and a copy access right not being assigned) may enable code editor 304 or other software development tool to display decrypted source code portion 322 without enabling decrypted source code portion 322 to be copied. In another example, the compile by user access right may be granted for a user, but not the read by user access right, so the user may be enabled to use compiler 306 to compile decrypted source code portion 322 without the user being enabled to read decrypted source code portion 322 (the code is not displayed to the user).

### B. Example Embodiments for Providing Access to Protected Source Code

As described above, source code access manager 110 is configured to provide access to source code by DRM enabled software development tools according to access rights. Source code access manager 110 may be configured in various ways, and may operate in various ways, in embodiments.

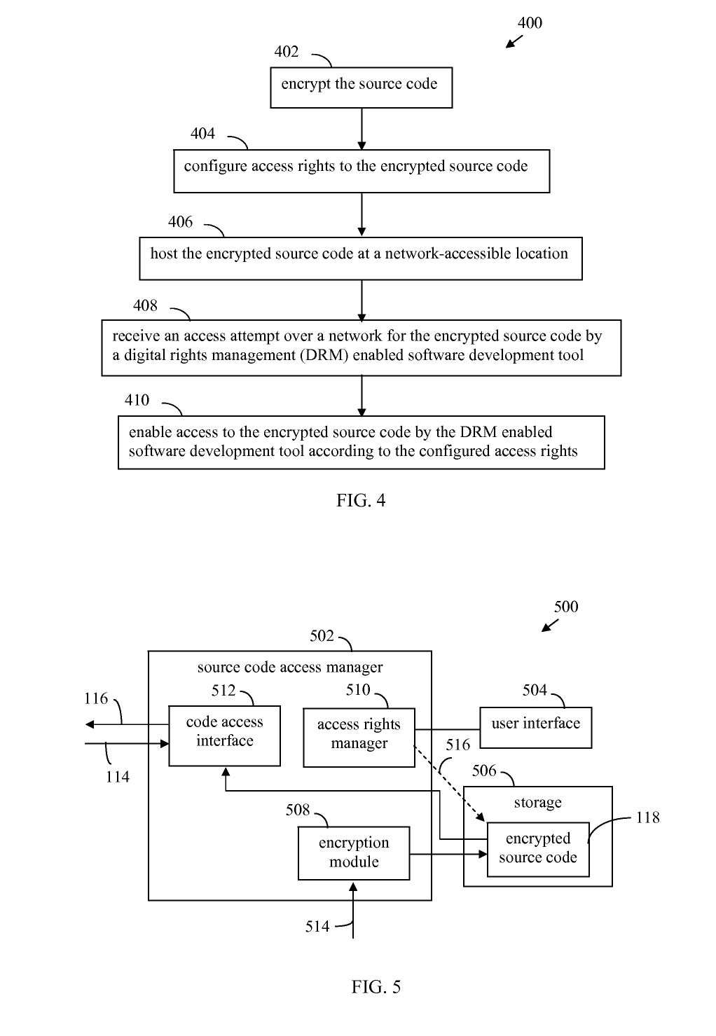

For instance, FIG. 4 shows a flowchart 400 providing a process for controlling access to source code by DRM enabled software development tools, according to an example embodiment. Source code access manager 110 of FIG. 1 may operate according to flowchart 400 in an embodiment. For purposes of illustration, flowchart 400 of FIG. 4 is described with respect to FIG. 5. FIG. 5 shows a block diagram of a system 500 in which a source code access manager 502 provides controlled access to source code, according to an example embodiment. Source code access manager 502 is an example of source code access manager 110 of FIG. 1. As shown in FIG. 5, system 500 includes source code access manager 502, a user interface 504, and storage 506. Source code access manager 502 includes an encryption module 508, an access rights manager 510, and a code access interface 512. Flowchart 400 and system 500 are described as follows. Further structural and operational embodiments will be apparent to persons skilled in the relevant art(s) based on the following description.

Flowchart 400 begins with step 402. In step 402, the source code is encrypted. For example, as shown in FIG. 5, encryption module 508 receives source code 514. Source code 514 may be received from a software development tool, from storage, or from another location. Encryption module 508 is configured to encrypt source code 514 to generate encrypted source code 118. Encryption module 508 may encrypt source code 514 according to any encryption technique or algorithm known to persons skilled in the relevant art(s) to generate encrypted source code 118, including a private-key encryption technique or a public-key encryption technique (e.g., PGP (pretty good privacy), etc.), content scrambling system (CSS), advanced encryption standard (AES), or other encryption algorithm. Although several examples of encryption techniques are mentioned, these examples are provided for purposes of illustration and are not intended to be limiting.

As shown in FIG. 5, encryption module 508 stores encrypted source code 118 in storage 506. Storage 506 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium to store encrypted source code 118.

Referring back to FIG. 4, in step 404, access rights to the encrypted source code are configured. In an embodiment, access rights for encrypted source code 118 may be automatically assigned by access rights manager 510 and/or may be manually assigned by a user interacting with user interface 504. User interface 504 is a user interface (e.g., graphical user interface (GUI), text editor interface, etc.) generated by access rights manager 510 to enable access rights to be assigned to source code by a developer or other user. The user may be enabled to select any of the access rights mentioned elsewhere herein or otherwise known, and apply them to any portion of (including the entirety of) the source code included in encrypted source code 118. The access rights may be displayed in a list in a selectable form, or may be displayed adjacent to selectable user interface elements (e.g., check boxes, radio buttons, etc.), to be configured and applied to source code. In an embodiment, user interface 504 may display an unencrypted form of encrypted source code 118 (e.g., source code 514) to enable the user to view the source code in plaintext to assist the user in assigning the access rights to the source code.

User interface 504 may have any number and combination of user interface elements that may be interacted with by a user. For instance, user interface 504 may be a graphical user interface (GUI) that includes one or more graphical user interface controls (e.g., text entry boxes, pull down menus, radio buttons, check boxes, etc.). User interface 504 may be interacted with by a user in any manner, such as by a keyboard, a thumb wheel, a pointing device, a roller ball, a stick pointer, a touch sensitive display (e.g., by using gesture input), a voice recognition system, and/or other user interface elements described elsewhere herein or otherwise known.

As shown in FIG. 5, access rights manager 510 associates the automatically and/or manually configured access rights to encrypted source code 118 as access rights information 516.

Note that steps 402 and 404 may be performed in either order. Furthermore, in step 404, each access right that is assigned may be assigned to any portion of the encrypted source code, including being assigned to one or more specific methods, classes, functions, etc., included in the encrypted source code, or being assigned to the entirety of the encrypted source code (e.g., assigned to the source code file). For instance, in one embodiment, a particular access right may be assigned to a first portion of the encrypted source code, while the particular access right is not assigned to a second portion of the encrypted source code (that is different than the first portion). Thus, access to the first portion of the encrypted source code is controlled at least in part by the particular access right, while access to the second portion of the encrypted source code is not affected by the particular access right.

Referring back to FIG. 4, in step 406, the encrypted source code is hosted at a network-accessible location. In an embodiment, source code access manager 502 is hosted in a network-accessible location, such as server 104 shown in FIG. 1. Code access interface 512 provides an interface for source code access manager 502 to communicate over a network (e.g., network 106 in FIG. 1). In an embodiment, source code access manager 502 may be hosted in one or more servers accessible over the Internet to be considered to be hosted in “the Cloud.”

In step 408, an access attempt is received over a network for the encrypted source code by a DRM enabled software development tool. For example, as shown in FIG. 5, code access interface 512 may receive request 114. Code access interface 512 may receive request 114 through a network interface included in or accessible to code access interface 512. As described above, request 114 is a request by a DRM enabled software development tool to access encrypted source code 118, such as software development tool 108a or software development tool 108b of FIG. 1, or code editor 304, compiler 306, debugger 308, static analysis tool 310, profiler 312, or deployment tool 314 of software development environment 300 in FIG. 3.

In step 410, access by the DRM enabled software development tool to the encrypted source code is enabled according to the configured access rights. As shown in FIG. 5, in response to request 114, code access interface 512 retrieves the requested portion of encrypted source code 118 from storage 506 (along with corresponding access rights information 516), and transmits the requested portion in encrypted source code portion 116 with the corresponding access rights information 516. Encrypted source code portion 116 may be received by the requesting software development tool, and interacted with in accordance with the corresponding access rights indicated in access rights information 516. The DRM functionality at the software development tool (e.g., DRM module 112a or DRM module 112b in FIG. 1, DRM module 302 in FIG. 3, etc.) restricts interaction with encrypted source code portion 116 according to the indicated access rights (e.g., as described further above).

### C. Further Example Embodiments

As described above, according to embodiments, software development tools may be DRM enabled to access source code having associated access rights. A source code access manager may enable access rights to be associated with source code, and may provide access to the source code for DRM enabled software development tools according to the configured access rights.

As described above, although encrypted source code is described as being transmitted from a source code access manager at a server to a software development tool at a separate computing device, in another embodiment, the source code access manager and software development tool may be located in the same computing device.

In still another embodiment, the encrypted source code may be maintained at the server (not downloaded to the computing device over the network), and the software development tool may operate on the encrypted source code over the network at the server.

In another embodiment, the encrypted source code and the software development tool may reside in a same computing device, while the source code access manager may be located at a separate server. For instance, an entire copy of the encrypted source may reside on the developer's computing device, but may still be subject to the same read/write/copy/etc. permissions based on the rights management techniques described herein. In an embodiment, the access rights information (e.g., access rights information 516) may be stored (e.g., cached) locally on the developer's computing device such that the developer has offline access to the source code (e.g., the developer does not need to rely on accessing the remote source code access manager when not connected by the network, but instead can have access to the source code as controlled by the locally cached access rights).

In still another embodiment, the source code access manager, encrypted source code, and software development tool may reside in a same computing device.

Furthermore, as shown in FIG. 3, a single DRM module (e.g., DRM module 302) may provide DRM functionality for multiple software development tools. In another embodiment, one or more of the software development tools (e.g., code editor 304, compiler 306, debugger 308, static analysis tool 310, profiler 312, deployment tool 314, etc.) may include its own DRM module.

### III. Example Computing Device Embodiments

Software development tool 108a, software development tool 108b, source code access manager 110, DRM module 112a, DRM module 112b, software development environment 300, DRM module 302, code editor 304, compiler 306, debugger 308, static analysis tool 310, profiler 312, deployment tool 314, code access requester 316, decryption module 318, access rights enforcement module 320, source code access manager 502, encryption module 508, access rights manager 5610, code access interface 512, flowchart 200, and flowchart 400 may be implemented in hardware, or hardware with any combination of software and/or firmware. For example, software development tool 108a, software development tool 108b, source code access manager 110, DRM module 112a, DRM module 112b, software development environment 300, DRM module 302, code editor 304, compiler 306, debugger 308, static analysis tool 310, profiler 312, deployment tool 314, code access requester 316, decryption module 318, access rights enforcement module 320, source code access manager 502, encryption module 508, access rights manager 5610, code access interface 512, flowchart 200, and/or flowchart 400 may be implemented as computer program code configured to be executed in one or more processors and stored in a computer readable storage medium. Alternatively, software development tool 108a, software development tool 108b, source code access manager 110, DRM module 112a, DRM module 112b, software development environment 300, DRM module 302, code editor 304, compiler 306, debugger 308, static analysis tool 310, profiler 312, deployment tool 314, code access requester 316, decryption module 318, access rights enforcement module 320, source code access manager 502, encryption module 508, access rights manager 5610, code access interface 512, flowchart 200, and/or flowchart 400 may be implemented as hardware logic/electrical circuitry.

For instance, in an embodiment, one or more of software development tool 108a, software development tool 108b, source code access manager 110, DRM module 112a, DRM module 112b, software development environment 300, DRM module 302, code editor 304, compiler 306, debugger 308, static analysis tool 310, profiler 312, deployment tool 314, code access requester 316, decryption module 318, access rights enforcement module 320, source code access manager 502, encryption module 508, access rights manager 5610, code access interface 512, flowchart 200, and/or flowchart 400 may be implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

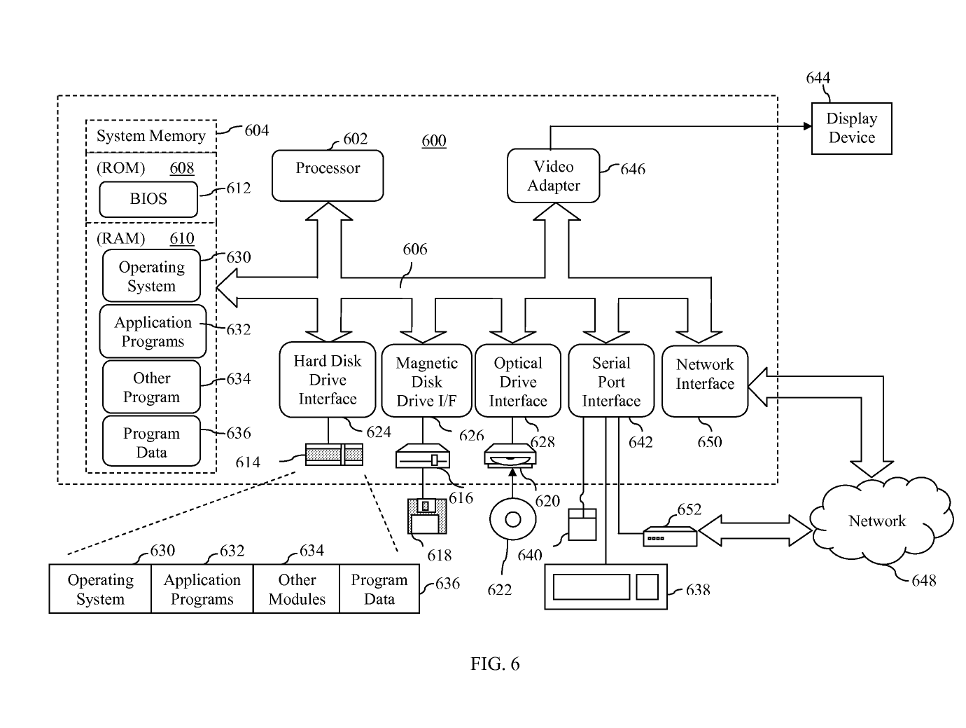

FIG. 6 depicts an exemplary implementation of a computer 600 in which embodiments of the present invention may be implemented. For example, computing device 102 and/or server 104 may be implemented in one or more computer systems similar to computer 600, including one or more features of computer 600 and/or alternative features. The description of computer 600 provided herein is provided for purposes of illustration, and is not intended to be limiting. Embodiments of the present invention may be implemented in further types of computer systems, as would be known to persons skilled in the relevant art(s).

As shown in FIG. 6, computer 600 includes one or more processors 602, a system memory 604, and a bus 606 that couples various system components including system memory 604 to processor 602. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computer 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. Application programs 632 or program modules 634 may include, for example, computer program logic (e.g., computer program code or instructions) for implementing software development tool 108a, software development tool 108b, source code access manager 110, DRM module 112a, DRM module 112b, software development environment 300, DRM module 302, code editor 304, compiler 306, debugger 308, static analysis tool 310, profiler 312, deployment tool 314, code access requester 316, decryption module 318, access rights enforcement module 320, source code access manager 502, encryption module 508, access rights manager 5610, code access interface 512, flowchart 200, and/or flowchart 400 (including any step of flowcharts 200 and 400), and/or further embodiments described herein.

A user may enter commands and information into the computer 600 through input devices such as keyboard 638 and pointing device 640. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 602 through a serial port interface 642 that is coupled to bus 606, but may be connected by other interfaces, such as a parallel port, game port, or a universal serial bus (USB).

A display component 644 is also connected to bus 606 via an interface, such as a video adapter 646. In addition to the monitor, computer 600 may include other peripheral output devices (not shown) such as speakers and printers.

Computer 600 is connected to a network 648 (e.g., the Internet) through an adaptor or network interface 650, a modem 652, or other means for establishing communications over the network. Modem 652, which may be internal or external, may be connected to bus 606 via serial port interface 642, as shown in FIG. 6, or may be connected to bus 606 using another interface type, including a parallel interface.

As used herein, the terms “computer program medium,” “computer-readable medium,” and “computer-readable storage medium” are used to generally refer to media such as the hard disk associated with hard disk drive 614, removable magnetic disk 618, removable optical disk 622, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 632 and other program modules 634) may be stored on the hard disk, magnetic disk, optical disk, ROM, or RAM. Such computer programs may also be received via network interface 650, serial port interface 642, or any other interface type. Such computer programs, when executed or loaded by an application, enable computer 600 to implement features of embodiments of the present invention discussed herein. Accordingly, such computer programs represent controllers of the computer 600.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a server for managing access rights to computer program source code, comprising:
encrypting the source code;
configuring access rights to the encrypted source code;
hosting the encrypted source code at a network-accessible location;
receiving an access attempt for the encrypted source code by a digital rights management (DRM) enabled software development tool; and
enabling access to the encrypted source code by the DRM enabled software development tool according to the configured access rights.

2. The method of claim 1, wherein the access rights include a read by user access right and a copy access right, the read by user access right assigned to the encrypted source code and the copy access right not assigned to the encrypted source code, wherein said enabling comprises:
enabling the DRM enabled software development tool to decrypt the encrypted source code and display the decrypted source code according to the read by user access right without enabling the decrypted source code to be copied at the DRM enabled software development tool.

3. The method of claim 1, wherein the access rights include a read by compiler access right and a read by user access right, the read by compiler access right assigned to the encrypted source code and the read by user access right not assigned to the encrypted source code, wherein said enabling comprises:
enabling the DRM enabled software development tool to decrypt the encrypted source code and compile the decrypted source code according to the read by compiler access right without enabling the decrypted source code to be read by a user at the DRM enabled software development tool.

4. The method of claim 1, wherein the said configuring access rights to the encrypted source code comprises:
assigning an access right to a first portion of the encrypted source code, the access right not assigned to a second portion of the encrypted source code.

5. The method of claim 1, wherein the access rights include a public metadata only access right, wherein said enabling comprises:
enabling the DRM enabled software development tool to decrypt the encrypted source code and display publicly available metadata associated with the source code without enabling the decrypted source code to be read at the DRM enabled software development tool according to the public metadata only access right.

6. The method of claim 1, wherein said receiving an access attempt comprises:
receiving the access attempt from a computing device over a network from the server.

7. The method of claim 1, wherein said receiving an access attempt comprises:
receiving the access attempt from the DRM enabled software development tool in the server.

8. A source code access manager in a server configured to manage access rights to computer program source code, comprising:
an encryption module configured to encrypt the source code;
an access rights manager configured to enable access rights to the encrypted source code to be configured; and
a code access interface configured to receive an access attempt for the encrypted source code by a digital rights management (DRM) enabled software development tool, and to enable access to the encrypted source code by the DRM enabled software development tool according to the configured access rights.

9. The source code access manager of claim 8, wherein the access rights include a read by user access right and a copy access right, the read by user access right assigned to the encrypted source code and the copy access right not assigned to the encrypted source code; and
the code access interface enables the DRM enabled software development tool to decrypt the encrypted source code and display the decrypted source code according to the read by user access right without enabling the decrypted source code to be copied at the DRM enabled software development tool.

10. The source code access manager of claim 8, wherein the access rights include a read by compiler access right and a read by user access right, the read by compiler access right assigned to the encrypted source code and the read by user access right not assigned to the encrypted source code; and
the code access interface enables the DRM enabled software development tool to decrypt the encrypted source code and compile the decrypted source code according to the read by compiler access right without enabling the decrypted source code to be read by a user at the DRM enabled software development tool.

11. The source code access manager of claim 8, wherein an access right is assigned to a first portion of the encrypted source code, and the access right not assigned to a second portion of the encrypted source code.

12. The source code access manager of claim 8, wherein the access attempt is received from a code editor, a compiler, a debugger, a static analysis tool, a profiler, or a deployment tool.

13. The source code access manager of claim 8, wherein the access rights include a public metadata only access right; and
the code access interface enables the DRM enabled software development tool to decrypt the encrypted source code and display publicly available metadata associated with the source code without enabling the decrypted source code to be read at the DRM enabled software development tool according to the public metadata only access right.

14. The source code access manager of claim 8, wherein the access rights include an associated license access right; and
the code access interface enables the DRM enabled software development tool to decrypt the encrypted source code and enable access to the decrypted source code according to the associated license access right.

15. A software development tool, comprising:
a digital rights management (DRM) module configured to enable DRM for the software development tool, the DRM module including
a code access requester configured to request and receive access to encrypted source code at a server over a network;
a decryption module configured to decrypt the encrypted source code; and
an access rights enforcement module configured to enable access to the decrypted source code according to access rights configured for the encrypted source code at the server.

16. The software development tool of claim 15, wherein the access rights include a read by user access right and a copy access right, the read by user access right assigned to the encrypted source code and the copy access right not assigned to the encrypted source code; and
the DRM enabled software development tool is enabled by the access rights enforcement module to display the decrypted source code according to the read by user access right without enabling the decrypted source code to be copied at the DRM enabled software development tool.

17. The software development tool of claim 15, wherein the access rights include a read by compiler access right and a read by user access right, the read by compiler access right assigned to the encrypted source code and the read by user access right not assigned to the encrypted source code; and
the DRM enabled software development tool is enabled by the access rights enforcement module to compile the decrypted source code according to the read by compiler access right without enabling the decrypted source code to be read by a user at the DRM enabled software development tool.

18. The software development tool of claim 15, wherein an access right is assigned to a first portion of the encrypted source code, and the access right not assigned to a second portion of the encrypted source code.

19. The software development tool of claim 15, wherein the access rights include a public metadata only access right; and
the DRM enabled software development tool is enabled by the access rights enforcement module to display publicly available metadata associated with the source code without the decrypted source code being enabled to be displayed at the DRM enabled software development tool according to the public metadata only access right.

20. The software development tool of claim 15, wherein the software development tool is a code editor, a compiler, a debugger, a static analysis tool, a profiler, or a deployment tool.
